(19) United States
(12) Patent Application Publication
(10) Pub. No.: US 2026/0278759 A1
(43) Pub. Date: Sep. 17, 2026

(54) ABNORMALITY DETERMINATION SYSTEM, ABNORMALITY DETERMINATION METHOD, AND PROGRAM

(71) Applicant: Nippon Seiki Co., Ltd., Niigata (JP)

(72) Inventors: Toui MORI, Niigata (JP); Yusuke KOIZUMI, Niigata (JP)

(21) Appl. No.: 19/469,640

(22) PCT Filed: Apr. 11, 2024
(86) PCT No.: PCT/JP2024/014613

§ 371 Date: Sep. 26, 2025

(30) Foreign Application Priority Data
Apr. 14, 2023 (JP) 2023-066267

(51) Int. Cl. G06T 7/00; H04N 5/77

(52) U.S. Cl. CPC G06T 7/0002; G06T 2207/10016; G06T 2207/20081; H04N 5/77

(57) ABSTRACT

Please replace the abstract in the specification as filed with the below paragraph as follows:

Provided are an abnormality determination system, an abnormality determination method, and a program that make it possible to more accurately determine the presence or absence of an abnormality. An abnormality determination system comprises: an HUD placement device for placing a test HUD device; a light irradiation control unit for performing control to cause the test HUD device to emit display light; cameras for outputting video data by imaging the display light; a prediction model for outputting prediction data, which is predicted next video data, when the video data is inputted; and an abnormality determination unit for determining whether or not there is an abnormality in the display light through comparison between the prediction data and actual measurement data. The prediction model is a model trained through machine learning using, as training data, normal video data obtained by imaging the display light emitted by a normal HUD device having no abnormality.

### TECHNICAL FIELD

The present disclosure relates to an abnormality determination system, an abnormality determination method, and a program.

### BACKGROUND ART

In a test device for a head-up display device described in Patent Document 1, an imaging unit illuminates a windshield via an optical element to generate a virtual image, and the virtual image is captured by a camera unit.

### PRIOR ART DOCUMENT

### Patent Document

Patent Document 1: JP 7189973 B

### SUMMARY OF INNOVATION

### Problems to be Solved by the Invention

The configuration of Patent Document 1 above leaves room for improvement in terms of accurately determining whether there is abnormality in a displayed image such as flicker.

The present disclosure has been made in consideration of the above-described circumstances, and an object thereof is to provide an abnormality determination system, an abnormality determination method, and a program that can more accurately determine whether there is abnormality.

### SOLUTION TO PROBLEM

To achieve the above object, an abnormality determination system according to a first aspect of the present disclosure is an abnormality determination system for determining whether there is abnormality in a head-up display device that displays a virtual image by emitting display light to a projection target member, including, a placement unit in which a head-up display device to be tested is placed, a light irradiation control unit that controls the head-up display device to emit display light, a camera that images the display light from the head-up display device to output video data, a prediction model that outputs prediction data, which is next predicted video data, in response to input of the video data, and an abnormality determination unit that determines, through comparison between the prediction data and actual video data, whether there is abnormality in the display light from the head-up display device. In the abnormality determination system, the prediction model is a model trained through machine learning using, as training data, normal video data obtained by imaging display light emitted by a normal head-up display device having no abnormality, or abnormal video data obtained by imaging display light emitted by an abnormal head-up display device.

To achieve the above object, an abnormality determination method according to a second aspect of the present disclosure is an abnormality determination method for determining whether there is abnormality in a head-up display device that displays a virtual image by emitting display light to a projection target member, including, placing, in a placement unit, a head-up display device to be tested, imaging, by a camera, display light from the head-up display device to output video data, generating a prediction model through machine learning using, as training data, normal video data obtained by imaging display light emitted by a normal head-up display device having no abnormality, or abnormal video data obtained by imaging display light emitted by an abnormal head-up display device, outputting prediction data, which is next predicted video data, by using the prediction model in response to input of the video data, and determining, through comparison between the prediction data and actual video data, whether there is abnormality in the display light from the head-up display device.

To achieve the above object, a program according to a third aspect of the present disclosure is a program causing a computer to realize, a function of inputting video data obtained by imaging, by a camera, display light emitted by a head-up display device, a function of generating a prediction model through machine learning using, as training data, normal video data obtained by imaging display light emitted by a normal head-up display device having no abnormality, or abnormal video data obtained by imaging display light emitted by an abnormal head-up display device, a function of outputting prediction data, which is next predicted video data, by using the prediction model in response to input of the video data, and a function of determining, through comparison between the prediction data and actual video data, whether there is abnormality in the display light.

### EFFECT OF THE INVENTION

According to the present disclosure, it is possible to more accurately determine whether there is abnormality.

### BRIEF DESCRIPTION OF DRAWINGS

FIG. 1 is a schematic view of a vehicle on which a head-up display device according to an embodiment of the present disclosure is mounted.

FIG. 2 is a block diagram of an abnormality determination system according to an embodiment of the present disclosure.

FIG. 3 is a flowchart of a prediction model generation process according to an embodiment of the present disclosure.

FIG. 4 is a flowchart of an abnormality determination process according to an embodiment of the present disclosure.

FIG. 5 is a graph showing a temperature change in a thermostatic chamber during a test period according to an embodiment of the present disclosure.

FIG. 6 is a diagram illustrating a recording time period when it is determined that there is abnormality according to an embodiment of the present disclosure.

FIG. 7 is a diagram illustrating frames input into a prediction model according to an embodiment of the present disclosure.

FIG. 8 is a diagram illustrating frames input into a prediction model according to an embodiment of the present disclosure.

### MODE FOR CARRYING OUT THE INVENTION

An embodiment of an abnormality determination system, an abnormality determination method, and a program according to the present disclosure will be described with reference to the drawings.

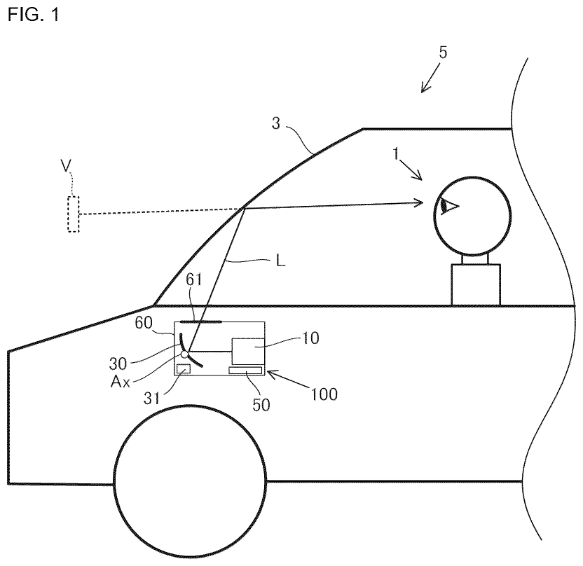

As illustrated in FIG. 1, a head-up display device 100 (hereinafter referred to as an HUD device 100) is installed in a dashboard of a vehicle 5. The HUD device 100 emits display light L that represents an image, to a windshield 3 that is a front glass of the vehicle 5. The display light L is reflected by the windshield 3 and reaches a viewer 1 (mainly a driver of the vehicle 5). In this manner, a virtual image V is displayed to be visible for the viewer 1.

The HUD device 100 includes a display unit 10, a concave mirror 30, a mirror drive unit 31, an HUD control unit 50, and a housing 60.

The display unit 10 emits the display light L under the control of the HUD control unit 50. The display unit 10 includes, for example, a liquid crystal panel (not illustrated) and an illumination device (not illustrated) that emits illumination light to the liquid crystal panel.

The display unit 10 is not limited thereto, and may include an organic Electro Luminescence (EL) display or a Digital Micro mirror Device (DMD).

The housing 60 is made of an opaque resin or metal and has a hollow, substantially rectangular parallelepiped shape. The housing 60 houses components of the HUD device 100. The housing 60 has an opening portion that opens toward the windshield 3. The housing 60 includes a window portion 61 that has a curved plate shape and closes the opening portion. The window portion 61 is made of a transparent resin such as an acrylic resin, through which the display light L is transmitted.

The concave mirror 30 reflects the display light L from the display unit 10 toward the windshield 3 while expanding the light.

Note that, although in this example, the display light L from the display unit 10 is directly emitted onto the concave mirror 30, the HUD device 100 may include a folding mirror that reflects the display light L from the display unit 10 to the concave mirror 30. The folding mirror is a plane mirror or a concave mirror.

The mirror drive unit 31 rotates the concave mirror 30 about a rotation axis Ax under the control of the HUD control unit 50. The rotation axis Ax extends in a width direction of the vehicle.

The HUD control unit 50 includes a central processing unit (CPU), a read only memory (ROM), a random access memory (RAM), etc., and controls the display unit 10 and the mirror drive unit 31. During testing of the HUD device 100, the HUD control unit 50 controls the display unit 10 and the mirror drive unit 31 in response to a command signal from a test control unit 210 of an abnormality determination system 200 described later.

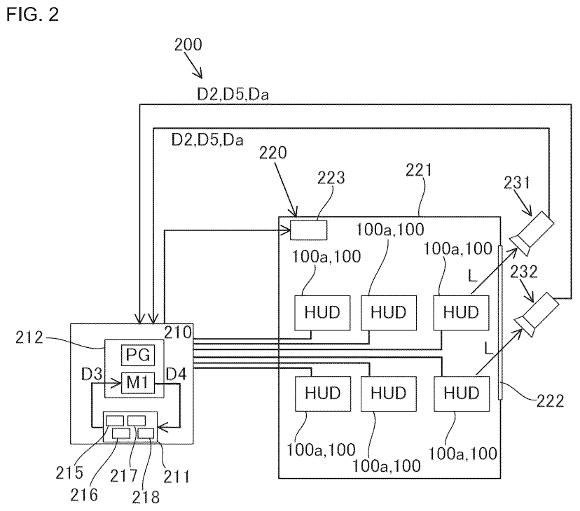

As illustrated in FIG. 2, the abnormality determination system 200 determines whether there is abnormality for a plurality of test HUD devices 100a, which are the above-mentioned HUD devices 100, during a test in which the test HUD devices 100a are caused to operate at a changing temperature. The abnormality is mainly flicker, which is a fluctuation in the luminance of an image represented by display light L. In addition to flicker, examples of the abnormality include blackouts during display operation, luminance suppression operation abnormality during luminance suppression operation (derating operation) at a high temperature, and discoloration of display, such as a reddish or yellowish tint on a displayed white color.

The abnormality determination system 200 includes cameras 231 and 232, the test control unit 210, and an HUD placement device 220.

The HUD placement device 220 includes a thermostatic chamber 221 and a temperature adjustment unit 223.

The thermostatic chamber 221 is a thermally insulated container having a housing space for housing the plurality of test HUD devices 100a.

The thermostatic chamber 221 includes a window portion 222 that allows the housing space to be viewed from the outside of the thermostatic chamber 221. The window portion 222 is formed in a plate shape and made of a light-transmissive material, such as glass or resin.

The temperature adjustment unit 223 controls the temperature inside the thermostatic chamber 221 under the control of the test control unit 210.

The cameras 231 and 232 are installed outside the thermostatic chamber 221 and can image, through the window portion 222, the display light L from the HUD device 100 inside the thermostatic chamber 221. The cameras 231 and 232 output captured video data D2 to the test control unit 210.

The test control unit 210 controls the cameras 231 and 232, the temperature adjustment unit 223, and the test HUD device 100a to test the test HUD device 100a. During the test, the test control unit 210 obtains prediction data D4 using a prediction model M1 based on video data D2 from the cameras 231 and 232, and determines whether there is abnormality in the test HUD device 100a by comparing the prediction data D4 with actual measurement data D5.

The test control unit 210 includes a processing unit 211 including a central processing unit (CPU) and the like, and a storage unit 212 including a read only memory (ROM), a random access memory (RAM). The storage unit 212 stores a program PG for executing a prediction model generation process, an abnormality determination process, and the like, which will be described later. The processing unit 211 includes, as functional blocks, an abnormality determination unit 215 that determines whether there is abnormality, a light irradiation control unit 216 that causes the HUD device 100 in the thermostatic chamber 221 to emit display light L, an operation control unit 217 that causes the test HUD device 100a to operate during testing, and an abnormality recording unit 218 that records video around the time of abnormality determination.

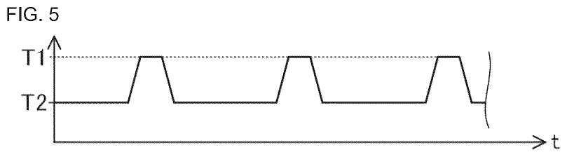

The test control unit 210 changes the temperature inside the thermostatic chamber 221 via the temperature adjustment unit 223 at regular intervals during the test period. As shown in FIG. 5, the test control unit 210 controls the temperature inside the thermostatic chamber 221 such that, during the test period, a period during which the temperature inside the thermostatic chamber 221 is at a first temperature T1 alternates with a period during which the temperature inside the thermostatic chamber 221 is at a second temperature T2. The first temperature T1 is higher than the second temperature T2. The period during which the temperature inside the thermostatic chamber 221 is set to the first temperature T1 is set to a time shorter than the period during which the temperature inside the thermostatic chamber 221 is set to the second temperature T2. In an example, the first temperature T1 is 95° C. and the second temperature T2 is 75° C.

During the test period, the operation control unit 217 performs switching among various states and operations of the test HUD device 100a according to a preset sequence. The test period is set to 24 hours or more, for example, a time in a range from 1000 to 3000 hours, and more specifically, 2000 hours.

Examples of the various states and operations described above include a non-energized state, a start-up standby state, a start-up operation, a display operation, a display change operation, and a termination operation.

The non-energized state is a state in which no power is applied to the test HUD device 100a.

The start-up standby state is a state in which the test HUD device 100a is energized and the test HUD device 100a is ready to start up.

The start-up operation is an operation of starting the test HUD device 100a and rotating the concave mirror 30 from a parking position to a display position via the mirror drive unit 31. The concave mirror 30 is oriented to guide the display light L to the viewer 1 when in the display position, and is oriented to guide the display light L in a direction different from the direction toward the viewer 1 when in the parking position.

The display operation is an operation of emitting display light L from the test HUD device 100a. The display change operation is an operation of changing the content of the image represented by the display light L via the display unit 10 of the test HUD device 100a.

The termination operation is an operation of rotating the concave mirror 30 from the display position to the parking position and then shutting down the HUD control unit 50 of the test HUD device 100a.

The test control unit 210 includes a test in which the start-up operation and the termination operation are alternately performed in the order of “start-up operation ==>termination operation ==>start-up operation ==>termination operation . . . ” during the test period.

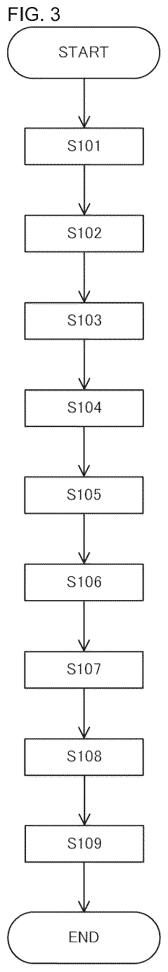

Next, the prediction model generation process executed by the test control unit 210 will be described with reference to a flowchart of FIG. 3. The prediction model generation process is executed before testing the test HUD device 100a.

Before starting the prediction model generation process, a normal HUD device 100 having no abnormality is placed in the thermostatic chamber 221.

The light irradiation control unit 216 causes the normal HUD device 100 to emit flicker-less normal display light L, and acquires, from the cameras 231, 232, normal video data Da obtained by imaging the display light L on the other side of the window portion 222 (step S101). It is desirable that this step S101 be performed in the same facility environment as the test.

In subsequent steps S102 to S108, the test control unit 210 processes the acquired normal video data Da into data that can be used for machine learning.

Specifically, first, if the angle of view included in the normal video data Da is unnecessarily wide, the unnecessary range of the video is cut out (step S102).

Then, the normal video data Da is subjected to Log conversion, which is a type of gradation conversion (step $103). This conversion allows luminance distribution in a histogram to be dispersed, and thus data suitable for machine learning can be prepared.

Next, the log-converted normal video data Da is subjected to difference conversion (step S104). The difference conversion is an image process of retaining only pixel values for which a change has been detected based on comparison between a current frame and the previous frame from video data consisting of successive frames.

Then, the average luminance of all pixels in the frame of the difference-converted normal video data Da is calculated (step S105). This average luminance of all pixels is calculated by averaging the RGB values of the pixels, or averaging V values of the HSV (hue, saturation, and value) values.

Next, once average luminance data for a predetermined number of frames (for example, 27 frames) from the normal video data Da is collected, the time-average luminance data is subjected to Fourier transform for decomposition into frequency components (step S106).

The result of Fourier transform is then filtered by a low-pass filter to cut off high-frequency components that are not visible to the human eye (step S107). The cutoff frequency of the low-pass filter is set to a frequency in a range from 20 Hz to 50 Hz.

As a result, high frequency components contained in the normal video data Da, such as those due to the blinking of a fluorescent light (50 Hz or 60 Hz) and the refresh rate of a display, are cut off. This display may be a display of the display unit 10 of the HUD device 100 and a display placed in the room in which the thermostatic chamber 221 is installed. When this display is a TFT display, the refresh rate is 60Hz. Flicker, which is a luminance abnormality, has a low frequency from about 2 to about 10 Hz and is therefore not cut off by the low-pass filter.

Next, the normal video data Da that has been subjected to the low-pass filter is subjected to an inverse Fourier transform for inverse conversion to time-average luminance data (step S108). In this manner, processed normal video data D1 that can be used for machine learning is prepared.

The test control unit 210 performs machine learning using, as training data, the processed normal video data D1 together with information that is flicker-less normal data. As a result, the prediction model M1 is generated as a trained model, and the generated prediction model M1 is stored in the storage unit 212 (step S109). The prediction model M1 is a model that receives, as input, a predetermined number of frames from the video data, and outputs prediction data of a frame following the predetermined number of frames.

Various models can be used in the machine learning, but in the case of handling data represented using a time axis, as in this case, it is desirable to use a model suitable for handling time-series data. Thus, in this case, it is preferable to use a long short-term memory (LSTM) model in the machine learning. The LSTM model is considered to be a model suitable for handling time-series data in a neural network. In this context, a model suitable for handling time series data refers to a model that, when time-series data from the past to the present is input, can output an expected input pattern after the time-series data. To construct the model, parameters whose effectiveness was confirmed in testing for implementation were selected.

This completes the prediction model generation process.

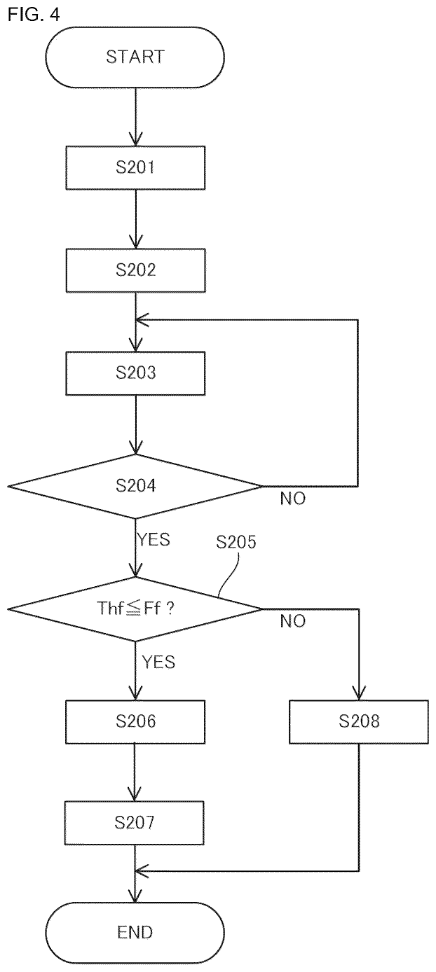

Next, the abnormality determination process executed by the test control unit 210 will be described with reference to the flowchart of FIG. 4. This abnormality determination process is executed repeatedly during the test.

First, the test control unit 210 acquires, from the cameras 231, 232, video data D2 obtained by imaging the display light L from the test HUD device 100a in the thermostatic chamber 221 (step S201).

Then, the test control unit 210 performs, on the video data D2, processes similar to steps S102 to S108 of the above-mentioned prediction model generation process to obtain processed video data D3 (step S202).

Next, once a predetermined number of frames (e.g., 27 frames) have accumulated as the most recent data of the processed video data D3, the abnormality determination unit 215 inputs the predetermined number of frames into the prediction model M1 to obtain prediction data D4 that predicts the next one frame (e.g., the 28th frame) following the predetermined number of frames (step S203). Each time step S203 is performed, prediction data D4 of one frame is obtained.

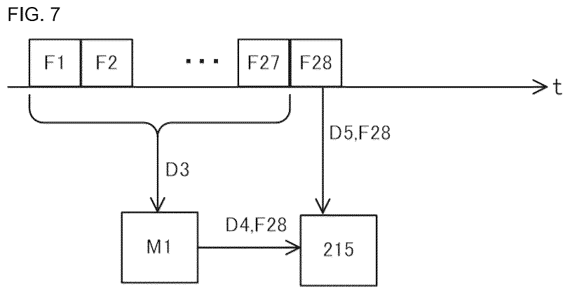

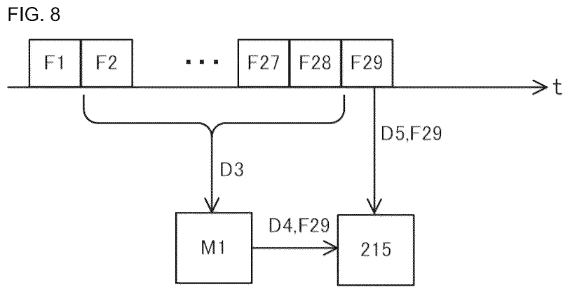

The abnormality determination unit 215 determines whether the number of frames of the prediction data D4 reaches a specified number (for example, 200) (step S204). If it is determined that the number of frames of the prediction data D4 does not reach the specified number, that is, that the number of frames of the prediction data D4 is less than the specified number (step S204; NO), the process of step S203 is performed again. For example, as illustrated in FIG. 7, in the first process of step S203, the first to 27th frames F1 to F27 are input as actual measurement data to the prediction model M1, and prediction data D4 for a 28th frame F28 is obtained. Next, as illustrated in FIG. 8, in the second process of step S203, the second to 28th frames F2 to F28 are input as actual measurement data to the prediction model M1, and prediction data D4 for a 29th frame F29 is obtained. That is, the process of step S203 described above is repeated while shifting, by one frame, frames to be processed, until the number of frames of the prediction data D4 reaches a specified number.

If the abnormality determination unit 215 determines that the number of frames of the prediction data D4 has reached the specified number (step S204; YES), the abnormality determination unit 215 performs comparison (error calculation) between the specified number of prediction data D4 (frames) and the specified number of actual measurement data D5 (frames), for each frame, as many times as the above-mentioned specified number (e.g., 200), and determines whether an abnormal frame count Ff is equal to or greater than a frame threshold Thf (step S205). In detail, for a given frame, if a luminance difference AL between a luminance value of the prediction data D4 and a luminance value of the actual measurement data D5 is equal to or greater than a luminance threshold Th1, the abnormal frame count Ff is incremented by one, and if the luminance difference AL is less than the luminance threshold Th1, the abnormal frame count Ff is not changed. The luminance threshold Th1 and the frame threshold Thf are set based on experiment or simulation to values above a luminance error.

The prediction data D4 is actually obtained as a collection of a plurality of luminance values distributed within a predetermined range. Therefore, the luminance difference AL between one luminance value which is the actual measurement data D5 and a plurality of luminance values which is the prediction data D4 may be calculated as the Mahalanobis distance.

If the abnormality determination unit 215 determines that the abnormal frame count Ff is less than the frame threshold Thf (step S205; NO), the abnormality determination unit 215 determines that there is no abnormality and the test HUD device is normal, notifies, via a display or the like (not illustrated), an operator that the test HUD device is normal (step S208), and terminates the abnormality determination process.

On the other hand, if the abnormality determination unit 215 determines that the abnormal frame count Ff is equal to or greater than the frame threshold Thf (step S205; YES), the abnormality determination unit 215 determines that there is abnormality (flicker), and notifies the operator of the abnormality via the display or the like (not illustrated) (step S206). In an example where the frame threshold Thf is set to 5, if comparison between prediction data D4 and actual measurement data D5 for 200 frames gives an abnormal frame count Ff of 5 or more, it is determined that there is abnormality.

Furthermore, the abnormality recording unit 218 stores the video data in the storage unit 212 to record video for a time period around a time of occurrence of abnormality, and the time period includes the time of occurrence of abnormality (step S207).

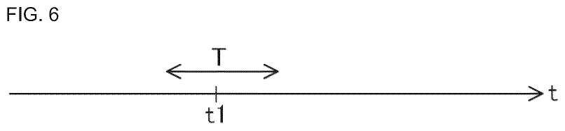

Specifically, as illustrated in FIG. 6, the abnormality recording unit 218 records video for a recording time period T around a time t1 at which it is determined that there is abnormality. The recorded video data is stored in the storage unit 212 such that the recorded video data can be replayed at a later time. The recording time period T is set to a time such that flicker may be captured in the recorded video, for example, several seconds to several tens of seconds including the time t1, and preferably about 30 seconds. In this example, the abnormality recording unit 218 always records video during the time period of the abnormality determination, and if there is no abnormality, the abnormality recording unit 218 sequentially deletes the recorded video data. The abnormality recording unit 218 does not delete the video data recorded before the time t1 when it is determined that there is abnormality, but retains the video data in the storage unit 212, and continues recording after the time t1. In this manner, video for a time period around a time of occurrence of abnormality can be recorded.

Note that, although, in this example, the recording time period T is set to a time period around the time t1, the recording time period T may be set only to a time period including the time t1 and a time period before the time t1, or only to a period including the time t1 and a time period after the time t1.

This completes the description of the abnormality determination process.

### Effects

According to the embodiment described above, the following effects are achieved.

(1) The abnormality determination system 200 determines whether there is abnormality in a test HUD device 100a that is the HUD device 100 that displays a virtual image V by emitting display light L to the windshield 3 that is an example of the projection target member. The abnormality determination system 200 includes, the HUD placement device 220 that is an example of a placement unit in which the test HUD device 100a to be tested is placed, the light irradiation control unit 216 that controls the test HUD device 100a to emit display light L, the cameras 231, 232 that images the display light L to output video data D2, the prediction model M1 that outputs prediction data D4, which is next predicted video data D2, in response to input of the video data D2, and the abnormality determination unit 215 that determines, through comparison between the prediction data D4 and actual measurement data D5 which is actual video data, whether there is abnormality in the display light L. The prediction model M1 is a model trained through machine learning using, as training data, normal video data Da obtained by imaging display light L emitted by a normal HUD device 100 having no abnormality.

This configuration makes it possible to more accurately determine whether there is abnormality.

Furthermore, abnormality determination can be performed automatically by the abnormality determination unit 215 without manual intervention.

Furthermore, since the actual display light L can be imaged by the cameras 231, 232, whether there is abnormality can be determined more accurately than with a method in which light source current of the HUD device is monitored.

(2) The abnormality determination system 200 includes the abnormality recording unit 218 that stores, in the storage unit 212, the video data D2 when the abnormality determination unit 215 determines that there is abnormality in the display light L, such that that video data D2 is replayable at a later time.

This configuration eliminates the need of storing the video for the entire period of the abnormality determination, and can save the storage space of the storage unit 212.

Furthermore, the operator can check only the video when an abnormality occurs, and thus this configuration makes it easy to perform checking work.

(3) The abnormality determination system 200 includes the operation control unit 217 that performs, for 24 hours or more, a test including causing the test HUD device 100 a to operate according to a preset operation sequence, concurrently with determining whether there is abnormality by the abnormality determination unit 215.

This configuration eliminates the need of checking by a human eye whether there is abnormality such as flicker, in a durability test of the test HUD devices 100a, which is conducted for a long time.

(4) The above operation sequence includes alternating a start-up operation and a termination operation of the test HUD device 100a.

(5) The HUD placement device 220 includes the thermostatic chamber 221 having a housing space for housing the test HUD device 100a, and the temperature adjustment unit 223 that changes the temperature of the housing space. The thermostatic chamber 221 includes the window portion 222 that transmits the display light L from the test HUD device 100a housed in the housing space. The cameras 231, 232 are provided outside the thermostatic chamber 221 and image the display light L transmitted through the window portion 222.

In this configuration, the cameras 231, 232 are not placed in an environment where the temperature is changed by the temperature adjustment unit 223. Therefore, there is no need to use special cameras such as heat-resistant cameras as the cameras 231, 232.

(6) The normal video data Da is video data obtained by imaging display light L emitted by a normal test HUD device 100a housed in the housing space and transmitted through the window portion 222.

In this configuration, the environment of the training data generation is the same as the environment of the abnormality determination. Therefore, even if the video imaged by the cameras 231, 232 includes unintended reflections at the window portion 222, a decrease in the accuracy of the abnormality determination can be suppressed.

(7) During a test period in which the abnormality determination unit 215 determines whether there is abnormality in the display light L, the temperature adjustment unit 223 alternately heats and cools the housing space by changing the temperature of the housing space between the first temperature T1 and the second temperature T2.

(8) The prediction model M1 is an LSTM model.

According to this configuration, as described above, the LSTM model is suitable for handling time-series data, which is video data, and thus, using the LSTM model as the prediction model M1 makes it possible to construct an optimal prediction model M1.

(9) As a result of comparing the prediction data D4 with the actual measurement data D5, if the difference between the prediction data D4 and the actual measurement data D5 is equal to or greater than a preset threshold (for example, the abnormal frame count Ff is equal to or greater than the frame threshold Thf), the abnormality determination unit 215 determines that there is abnormality in the display light L, and if the difference between the prediction data D4 and the actual measurement data D5 is less than the threshold (for example, the abnormal frame count Ff is less than the frame threshold Thf), the abnormality determination unit 215 determines that there is no abnormality in the display light L.

This configuration makes it possible to easily determine whether there is abnormality.

(10) An abnormality determination method for determining whether there is abnormality in a test HUD device 100a that displays a virtual image V by emitting display light L to the windshield 3 includes, placing a test HUD device 100a to be tested in the HUD placement device 220, generating the prediction model M1 through machine learning using, as training data, normal video data Da obtained by imaging display light L emitted by a normal test HUD device 100a having no abnormality, imaging, by the cameras 231, 232, display light L to output video data D2, outputting prediction data D4, which is next predicted video data, by using the prediction model M1 in response to input of the video data D2, and determining, through comparison between the prediction data D4 and actual measurement data D5, whether there is abnormality in the display light L.

This configuration makes it possible to more accurately determine whether there is abnormality.

(11) The program PG causes the test control unit 210 which is an example of a computer to realize, a function of inputting video data D2 obtained by imaging, by the cameras 231, 232, display light L emitted by a test HUD device 100a, a function of generating the prediction model M1 through machine learning using, as training data, normal video data Da obtained by imaging display light L emitted by a normal test HUD device 100a having no abnormality, a function of outputting prediction data D4, which is next predicted video data, by using the prediction model M1 in response to input of the video data D2, and a function of determining, through comparison between the prediction data D4 and actual measurement data D5, whether there is abnormality in the display light L.

This configuration makes it possible to more accurately determine whether there is abnormality.

Note that the present disclosure is not limited to the above-described embodiments and drawings. Appropriate modifications (including deletion of components) may be made without departing from the spirit of the present disclosure. Example variations will be described below.

### Variations

In the above embodiment, the test control unit 210 generates the prediction model M1 through machine learning using, as training data, the processed normal video data D1 obtained by processing the flicker-less normal video data Da, and information that there is no flicker. However, the prediction model may be generated by machine learning using, as training data, processed abnormal video data obtained by processing abnormal video data including flicker, and information that there is flicker. This prediction model is a model trained through machine learning using, as training data, abnormal video data obtained by imaging display light L emitted by a test HUD device 100a having abnormality. This prediction model predicts prediction data that is video data expected when there is abnormality. Therefore, if a luminance difference AL between a luminance value of the prediction data predicted by this prediction model and a luminance value of the actual measurement data D5 is less than a luminance threshold Th1, the abnormal frame count Ff is incremented by one, and if the luminance difference AL is equal to or greater than the luminance threshold Th1, the abnormal frame count Ff is not changed.

In the above embodiment, the display light L from the HUD device 100, 100a passes through the window portion 222 before reaching the cameras 231, 232. However, in addition to or instead of the window portion 222, another transmissive portion made of a light-transmissive material such as resin or glass may be provided. Alternatively, the window portion 222 may be omitted.

The prediction model M1 may be a model other than the LSTM model.

The abnormality recording unit 218 may record video throughout the test period and store a time of abnormality determination in the storage unit 212, instead of recording video around the time of abnormality determination. Alternatively, the abnormality recording unit 218 may be omitted.

The temperature inside the thermostatic chamber 221 during the test may be constant, and the temperature adjustment unit 223 may be omitted.

The concave mirror 30 may be non-rotatable about the rotation axis Ax. In this case, the mirror drive unit 31 is omitted.

In the above embodiment, the abnormality to be determined by the abnormality determination unit 215 is flicker. However, luminance abnormality other than flicker, display abnormality such as incorrect display of display content, or the like may be determined.

In the above embodiment, the abnormality determination system 200 includes the two cameras 231, 232, but the number of cameras may be one or three or more.

Furthermore, in the above embodiment, each camera images the display light L from one of the test HUD devices 100a, but one camera may simultaneously image the display light L from the plurality of test HUD devices 100a. In this case, the test control unit 210 can determine whether there is abnormality in the plurality of test HUD devices 100a by using the one camera.

Furthermore, the cameras 231, 232 may be provided inside the thermostatic chamber 221.

In the above embodiment, the cutoff frequency of the low-pass filter is set to a frequency in a range from 20 Hz to 50 Hz to detect abnormalities visually recognizable by the human eye, but the cutoff frequency is not limited thereto. Thus, the upper limit frequency of the range may be set to a frequency above 50 Hz to detect abnormalities in design specifications. The upper limit frequency may be set, for example, to a frequency that is a few Hz (for example, from 1 Hz to 3 Hz) lower than the refresh rate of the display being used. Specifically, for example, if the refresh rate of the display is 60 Hz, setting the upper limit frequency to a frequency in a range from about 59 Hz to 57 Hz makes it possible to detect an unintended blinking phenomenon with a frequency of 55 Hz. In other words, setting the cutoff frequency within that range makes it possible to detect failing to achieve an intended design frequency, although that phenomenon is imperceptible to humans.

The test operation in the above embodiment does not necessarily require alternating the start-up operation and the termination operation. For example, the test operation may include only the start-up operation, or may include only the termination operation.

Furthermore, the test operation may not include the start-up operation and the termination operation, i.e., the device may be in operation at the start of the test.

The manner in which the temperature inside the thermostatic chamber 221 is changed during the test period is not limited to the above embodiment, and the temperature may be changed to a temperature other than the temperatures T1, T2, or may be changed irregularly.

The program PG in the above embodiment may be stored in a computer-readable recording medium, such as a Universal Serial Bus (USB) flash drive, a CD-ROM, a Digital Versatile Disk (DVD), or a Hard Disk Drive (HDD), or may be downloaded to a computer via a network.

In the above embodiment, the HUD device 100 is mounted on the vehicle 5, but the HUD device 100 may be mounted on a vehicle other than the vehicle 5, such as an aircraft, a watercraft, or the like. Furthermore, the projection target member is not limited to the windshield 3 and may be a dedicated combiner.

### DESCRIPTION OF REFERENCE NUMERALS

1 Viewer
3 Windshield
5 Vehicle
10 Display unit
30 Concave mirror
31 Mirror drive unit
50 HUD control unit
60 Housing
61 Window portion
100 Head-up display device
100a Test HUD device
200 Abnormality determination system
210 Test control unit
211 Processing unit
212 Storage unit
215 Abnormality determination unit
216 Light irradiation control unit
217 Operation control unit
218 Abnormality recording unit
220 HUD placement device
221 Thermostatic chamber
222 Window portion
223 Temperature adjustment unit
231, 232 Camera
D1 Processed normal video data
D2 Video data
D3 Processed video data
D4 Prediction data
D5 Actual measurement data
Da Normal video data
L Display light
V Virtual image
M1 Prediction model
T1 First temperature
T2 Second temperature
PG Program
Ff Abnormal frame count
t1 Time
Ax Rotation axis
Thf Frame threshold

1. An abnormality determination system for determining whether there is abnormality in a head-up display device that displays a virtual image by emitting display light to a projection target member, the system comprising:
a placement unit in which a head-up display device to be tested is placed;
a light irradiation control unit that controls the head-up display device to emit display light;
a camera that images the display light from the head-up display device to output video data;
a prediction model that outputs prediction data in response to input of the video data, the prediction data being next predicted video data; and
an abnormality determination unit that determines, through comparison between the prediction data and actual video data, whether there is abnormality in the display light from the head-up display device, wherein
the prediction model is a model trained through machine learning using, as training data, normal video data obtained by imaging display light emitted by a normal head-up display device having no abnormality, or abnormal video data obtained by imaging display light emitted by an abnormal head-up display device.

2. The abnormality determination system according to claim 1, comprising an abnormality recording unit that stores the video data from the camera when the abnormality determination unit determines that there is abnormality in the display light, such that that video data is replayable at a later time.

3. The abnormality determination system according to claim 1, comprising an operation control unit that performs, for 24 hours or more, a test including causing the head-up display device to operate according to a preset operation sequence, concurrently with determining whether there is abnormality by the abnormality determination unit.

4. The abnormality determination system according to claim 3, wherein the operation sequence includes alternating a start-up operation and a termination operation of the head-up display device.

5. The abnormality determination system according to claim 1, wherein
the placement unit includes,
a thermostatic chamber having a housing space for housing the head-up display device, and
a temperature adjustment unit that changes a temperature of the housing space,
the thermostatic chamber includes a window portion that transmits the display light from the head-up display device housed in the housing space, and
the camera is provided outside the thermostatic chamber and images the display light transmitted through the window portion.

6. The abnormality determination system according to claim 5, wherein
the normal video data is video data obtained by imaging flicker-less display light emitted by the normal head-up display device housed in the housing space and transmitted through the window portion and/or another transmissive portion, and
the abnormal video data is video data obtained by imaging flickering display light emitted by the abnormal head-up display device housed in the housing space and transmitted through the window portion and/or the transmissive portion.

7. The abnormality determination system according to claim 5, wherein, during a test period in which the abnormality determination unit determines whether there is abnormality in the display light, the temperature adjustment unit alternately heats and cools the housing space by changing the temperature of the housing space between a first temperature and a second temperature.

8. The abnormality determination system according to claim 1, wherein the prediction model is a long short-term memory (LSTM) model.

9. An abnormality determination method for determining whether there is abnormality in a head-up display device that displays a virtual image by emitting display light to a projection target member, the method comprising:
placing, in a placement unit, a head-up display device to be tested;
by a camera, imaging display light from the head-up display device to output video data;
generating a prediction model through machine learning using, as training data, normal video data obtained by imaging display light emitted by a normal head-up display device having no abnormality, or abnormal video data obtained by imaging display light emitted by an abnormal head-up display device;
outputting prediction data by using the prediction model in response to input of the video data, the prediction data being next predicted video data; and
determining, through comparison between the prediction data and actual video data, whether there is abnormality in the display light from the head-up display device.

10. A program causing a computer to realize:
a function of inputting video data obtained by imaging, by a camera, display light emitted by a head-up display device;
a function of generating a prediction model through machine learning using, as training data, normal video data obtained by imaging display light emitted by a normal head-up display device having no abnormality, or abnormal video data obtained by imaging display light emitted by an abnormal head-up display device;
a function of outputting prediction data by using the prediction model in response to input of the video data, the prediction data being next predicted video data; and
a function of determining, through comparison between the prediction data and actual video data, whether there is abnormality in the display light.
